(19) United States
(12) Patent Application Publication
(10) Pub. No.: US 2015/0332006 A1
(43) Pub. Date: Nov. 19, 2015

(54) PATIENT HEALTH MEASUREMENT AND INCENTIVE SYSTEM

(71) Applicant: Bright House Networks, LLC, East Syracuse, NY (US)

(72) Inventors: Mark E. Swanson, St. Petersburg, FL (US); Leo Cloutier, Falls Church, VA (US)

(73) Assignee: Bright House Networks, LLC, East Syracuse, NY (US)

(21) Appl. No.: 14/279,474

(22) Filed: May 16, 2014

(51) Int. Cl. G06F 19/00

(52) U.S. Cl. CPC G06F 19/3406; G06F 19/3475

(57) ABSTRACT

Mechanisms for patient health monitoring are disclosed. A health server device receives a first message that originates from a media device associated with a patient. The first message indicates that the patient desires a service from the media device. A patient protocol of the patient is accessed, and a health data determination is made based on the patient protocol. An action is performed based on the health data determination.

### TECHNICAL FIELD

The embodiments relate generally to monitoring in-home health measurements of a patient, and in particular, to controlling the behavior of a media device associated with the patient based on the health measurements.

### BACKGROUND

There is continuing pressure to control health care costs while increasing the level of health care provided to patients. Often health care costs of a patient might have been reduced had the patient sought medical care earlier than it was sought, or had the patient played an active role in monitoring their own health. Sometimes a medical provider is aware of a health issue, such as high blood pressure, obesity, or diabetes, that is associated with a patient and which is quite suitable for patient monitoring. If health measurements are properly taken by the patient, the health measurements may provide early indicators of imminent medical conditions, and/or provide feedback to the patient and/or the doctor that the patient may or may not be following the instructions of the health care provider with respect to lifestyle changes necessary to bring about desired changes in health measurements, such as lower blood pressure readings, reduced weight scale readings, and the like.

Unfortunately, in practice, patient compliance with such prescribed protocols is relatively low. Sometimes non-compliance is due to ignorance regarding use of the device or devices necessary to take the prescribed health measurements, but more often non-compliance may be due to patient apathy, or apprehension, regarding what the health measurements may indicate. Consequently, the medical condition may worsen, and ultimately result in a potentially costly trip to a physician or a hospital emergency room, which may have been avoided had the health measurements been taken, and the patient and/or physician had been alerted to a medical condition that was not improving, or was gradually worsening.

### SUMMARY

The embodiments relate to a patient health monitoring and incentive system. In one embodiment, a media device, such as a set-top box, a digital video recorder, a smartphone, or the like, receives a first request for a service. In response to receiving the first request, the media device sends a first message to a remote health server device. The media device receives, from the remote health server device, a second message containing presentation content that indicates that a health measurement of a patient associated the media device is an undesirable health measurement. The media device presents the presentation content to the patient in lieu of the service.

In another embodiment, a health server device receives a first message that originates from a media device associated with a patient. The first message indicates that the patient desires a service from the media device. A patient protocol of the patient is accessed, and a health data determination is made based on the patient protocol. An action is performed based on the health data determination.

In one embodiment, the health data determination is made by accessing a health measurement associated with the patient from the patient protocol. The health measurement identifies a physiologic measurement of the patient. The health server device determines that the health measurement is a desirable health measurement, and in response to the determination, sends a message to the media device to provide the service to the patient.

In another embodiment, the health server device determines that the health measurement is an undesirable health measurement, and in response to the determination, sends presentation content to the media device for presentation to the patient in lieu of the service. In one embodiment, the presentation content comprises content related to improving future health measurements.

In one embodiment, upon the determination that the health measurement is an undesirable health measurement, the health server device sends a message to a physician computing device associated with the patient. The message includes the health measurement of the patient.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 is a block diagram of an environment in which embodiments may be practiced;

FIG. 2 is a high level flowchart of a method for monitoring compliance of a patient protocol according to one embodiment;

FIG. 3 is a block diagram of another environment in which embodiments may be practiced;

FIG. 4 is a block diagram of an example patient profile illustrating example data that may be stored in the patient profile;

FIG. 5 is a flowchart of a method for communicating health data to a health server device via a consumer gateway device according to one embodiment;

FIG. 6 is a flowchart of a method performed by a media device for ensuring compliance with a patient protocol prior to providing services to the patient, according to one embodiment;

FIG. 7 is a flowchart of a method for providing services to the patient after the patient has complied with the patient protocol, according to one embodiment;

FIG. 8 is a flowchart of a method for providing services to the patient after the patient has complied with the patient protocol, according to another embodiment;

FIG. 9 is a diagram of example presentation content that may be presented on a television that is coupled to the media device;

FIG. 10 is a diagram of example presentation content that may be displayed on a media device that comprises a computer tablet or a smartphone;

FIG. 11 is a block diagram of the environment illustrated in FIG. 3 according to another embodiment;

FIG. 12 is a flowchart of a method by which the health server device may monitor health measurements of the patient according to one embodiment;

FIG. 13 is a block diagram of example presentation content that may be displayed or otherwise presented by the media device on a television when the health server device makes a patient health data determination that the health measurement received from the patient is out of a desired range;

FIG. 14 is a block diagram of a health server device according to one embodiment;

FIG. 15 is a block diagram of a media device according to one embodiment;

FIG. 16 is a block diagram of a health measurement device according to one embodiment; and

FIG. 17 is a block diagram of the consumer gateway device according to one embodiment.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the embodiments are not limited to any particular sequence of steps. The use herein of ordinals in conjunction with an element is solely for distinguishing what might otherwise be similar or identical labels, such as “first message” and “second message,” and does not imply a priority, a type, an importance, or other attribute, unless otherwise stated herein.

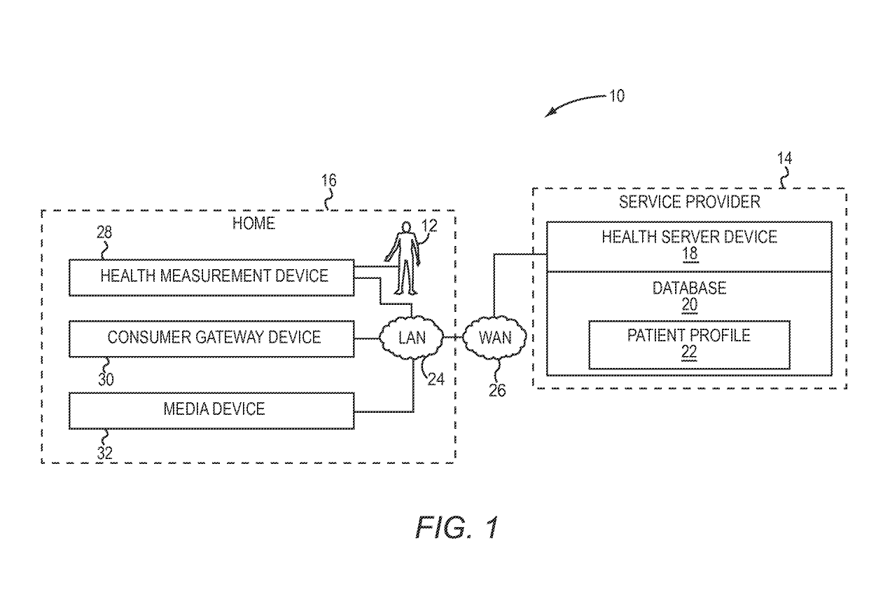

FIG. 1 is a block diagram of an environment 10 in which embodiments may be practiced. The environment 10 typically includes a patient 12, sometimes referred to herein as a user, who has a health care issue for which monitoring is desired. The patient 12 has a relationship with a service provider 14. The relationship may be, for example, contractual, wherein the service provider 14 provides the patient 12 no-cost, or reduced cost, services in return for allowing the service provider 14 to provide health care monitoring services, as described in greater detail herein. In some embodiments, the service provider 14 may comprise, for example, a multiple-system operator (MSO), a satellite television service provider, a wireless phone service provider, or any other service provider capable of communicating remotely with devices in a home 16 of the patient 12. In some embodiments, the patient 12 may already receive media or telephone services from the service provider 14, and in return for allowing the service provider 14 to provide health care monitoring services, as described herein, the service provider 14 may reduce or even eliminate existing fees for such media or telephone services.

The service provider 14 houses one or more health server devices 18, which provide services as described in greater detail herein. The health server device 18 may comprise, for example, one or more computer servers or telecommunication switches. The health server device 18 is coupled to or integrated with a storage structure that stores data, such as a database 20. Stored in the database 20 is a patient profile 22 that is associated with the patient 12. The patient profile 22, as will be described in greater detail herein, contains information about the patient 12, including a prescribed patient protocol that defines what health measurements the patient 12 is prescribed to take, and on what periodic basis. The phrase “health measurement,” as used herein, refers to a value that quantifies a physiologic condition of the patient 12, such as, for example, core body temperature, weight, blood pressure, respiratory rate, pulse, concentration of glucose in the blood, or the like. The health server device 18 is communicatively coupled to a local area network (LAN) 24 via a wide area network (WAN) 26. The WAN 26 may comprise any public network, such as the internet, or a proprietary network, or any combination thereof. In some embodiments, such as where the service provider 14 is an MSO, the WAN 26 may comprise a hybrid-fiber coax WAN. In other embodiments, such as where the service provider 14 is a wireless telephone service provider, the WAN 26 may comprise a cellular WAN. The LAN 24 may comprise any one or more technologies such as Wi-Fi, Bluetooth®, Zigbee®, or any other local or personal area network technology, or combination thereof, that facilitates communication between devices in the home 16.

A health measurement device (HMD) 28 is located in the home 16 and is used to take health measurements of the patient 12. The HMD 28 may comprise any device capable of quantifying some health-related aspect of the patient 12, such as, for example, core body temperature, weight, blood pressure, respiratory rate, pulse, concentration of glucose in the blood, or the like. In some embodiments, the HMD 28 may comprise a weight scale, a glucometer, a blood pressure monitor, or the like. A consumer gateway device 30 is also located in the home 16. The consumer gateway device 30 is operative to communicatively couple to the HMD 28 and thereby receive health measurements and/or other information from the HMD 28 either wirelessly or via a wired connection. The consumer gateway device 30 may communicatively couple with the HMD 28 by any known LAN or WAN technology as discussed above.

One or more media devices 32 are also located in the home 16. A media device 32 may comprise any device capable of providing media, such as images, audio, video, or the like, and present such media either directly or indirectly to the patient 12. The media device 32, by way of non-limiting example, may comprise, for example, a personal computer, a set-top box (STB), a digital video recorder (DVR), a media streaming device, a computer tablet, a smartphone, or the like.

The patient 12 is prescribed, by a physician, a patient protocol that identifies periodic health measurements that are to be taken by the patient 12 via the HMD 28. When the patient 12 takes a health measurement via the HMD 28, the HMD 28 communicatively couples to the consumer gateway device 30 and sends the health measurement to the consumer gateway device 30. The consumer gateway device 30 receives the health measurement, and communicates health information that includes the health measurement, and a health measurement device type that identifies the device type of the HMD 28, to the health server device 18 via the WAN 26. In some embodiments, the health information may be encrypted by the consumer gateway device 30 prior to communicating the health information to the health server device 18. The health server device 18 stores the health information in the patient profile 22. Over time, one or more health measurements taken by the patient 12 via the HMD 28 are maintained or otherwise stored in the patient profile 22. Because the health server device 18 is located remotely from the home 16, the health server device 18 may be referred to herein as a remote health server device 18.

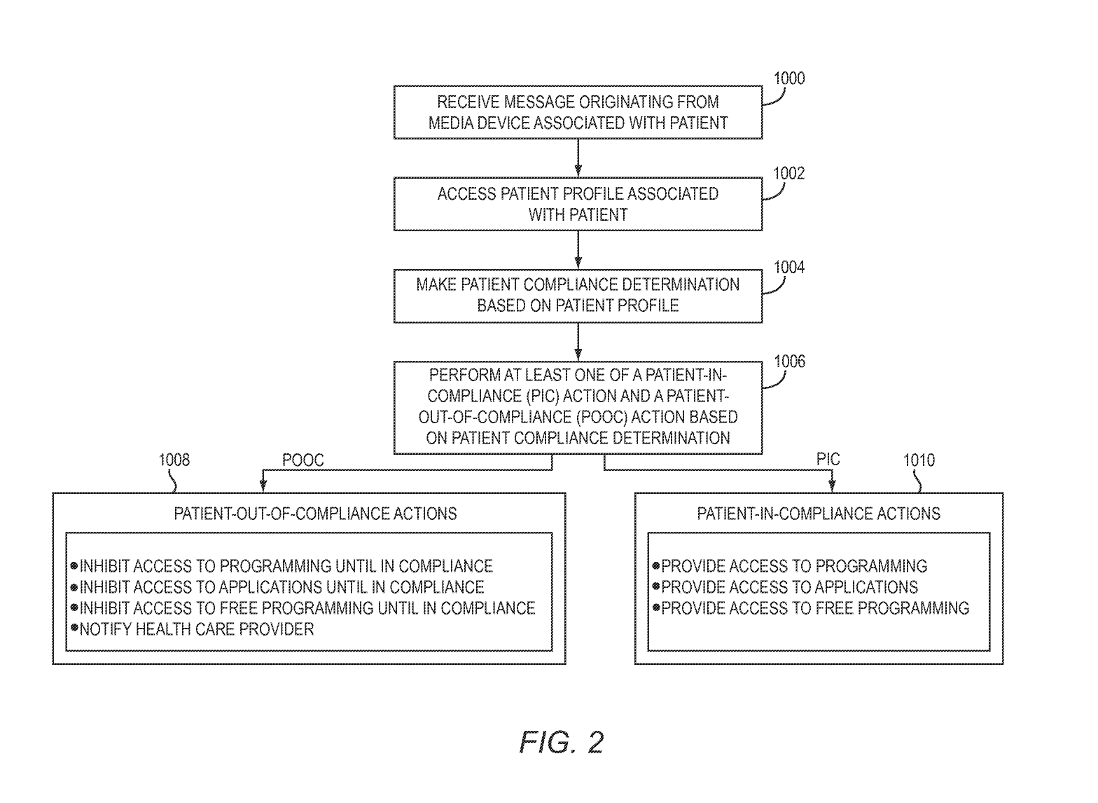

In one embodiment, the service provider 14, via the health server device 18, monitors compliance with the patient protocol identified in the patient profile 22 when the patient 12 desires to utilize the media device 32. In this regard, FIG. 2 is a high-level flowchart of a method for monitoring compliance of a patient protocol according to one embodiment. Assume for purposes of illustration that the media device 32 comprises a STB, and the patient 12 desires to watch television via the media device 32. The patient 12 turns on the media device 32. The media device 32 generates a message that indicates the patient 12 desires service from the media device 32 and sends the message to the health server device 18. The health server device 18 receives the message originating from the media device 32 (FIG. 2, block 1000). The health server device 18 accesses the patient profile 22 associated with the patient 12 (FIG. 2, block 1002). The health server device 18 makes a patient compliance determination based on the patient profile 22 (FIG. 2, block 1004). For example, the health server device 18 may review the prescribed patient protocol for the patient 12 and analyze the health measurements received via the consumer gateway device 30 for the patient 12 to determine whether the received health measurements comply with the prescribed patient protocol. The health server device 18 then performs either a patient-in-compliance action (PIC) or a patient-out-of-compliance (POOC) action based on the patient compliance determination (FIG. 2, block 1006).

Example POOC actions 1008, by way of non-limiting example, may include inhibiting access to the receipt of services, such as television programming, via the media device 32 until the patient 12 is in compliance with the patient protocol. This POOC action 1008 may be particularly suitable where the service provider 14 provides television programming to the patient 12. In some embodiments, the incentive to the patient 12 for allowing the service provider 14 to provide monitored health care services is that the patient 12 may receive no-cost or reduced cost programming from the service provider 14 in return for allowing the service provider 14 to provide health monitoring services to the patient 12.

Another POOC action 1008 may include inhibiting access to applications that may run on the media device 32. For example, the media device 32 may include one or more applications that may be initiated by the patient 12, such as a Netflix® application or an HBOGO® application. The health server device 18 may send a message to the media device 32 that inhibits access to such applications by the patient 12 until the patient 12 is in compliance with the patient protocol identified in the patient profile 22. Another POOC action 1008 may comprise notifying a health care provider that the patient 12 is not in compliance with the patient protocol identified in the patient profile 22. The health server device 18 may perform any one or more of such POOC actions 1008 in response to the patient compliance determination.

PIC actions 1010, by way of non-limiting example, may include providing access to special television programming, such as a movie channel that the patient 12 does not otherwise subscribe to, via the media device 32 if the patient 12 is in compliance with the patient protocol identified in the patient profile 22. Another PIC action 1010 may include providing access to applications that may execute on the media device 32 if the patient 12 is in compliance with the patient protocol. Another PIC action 1010 may include allowing the patient 12 to access standard television programming, which, in return for allowing the service provider 14 to provide health care monitoring services, may be provided to the patient 12 at no cost, or at a reduced cost.

In some embodiments, the service provider 14 may implement the POOL actions 1008 and the PIC actions 1010 via a communication protocol between the health server device 18 and the media device 32. In particular, the media device 32 may receive messages from the health server device 18 that identify whether the patient 12 is in compliance with the patient protocol, in which case, the media device 32 may provide the patient 12 with the requested service, or the media device 32 may receive a message from the health server device 18 indicating that the patient 12 is out-of-compliance with the patient protocol, in which case, the media device 32 may prevent the patient 12 from receiving the requested service. In some embodiments, the message(s) from the health server device 18 include presentation content which may be provided to the patient 12 in lieu of the requested service. Such presentation content may direct the patient 12 to perform one or more health care tasks in order to become compliant with the respective patient protocol.

In some embodiments, the presentation content may include a code to access free media content as a reward if the patient 12 complies with the patient protocol. As an example, the presentation content may direct the patient 12 to a complementary on-demand movie in return for continued compliance with the respective patient protocol.

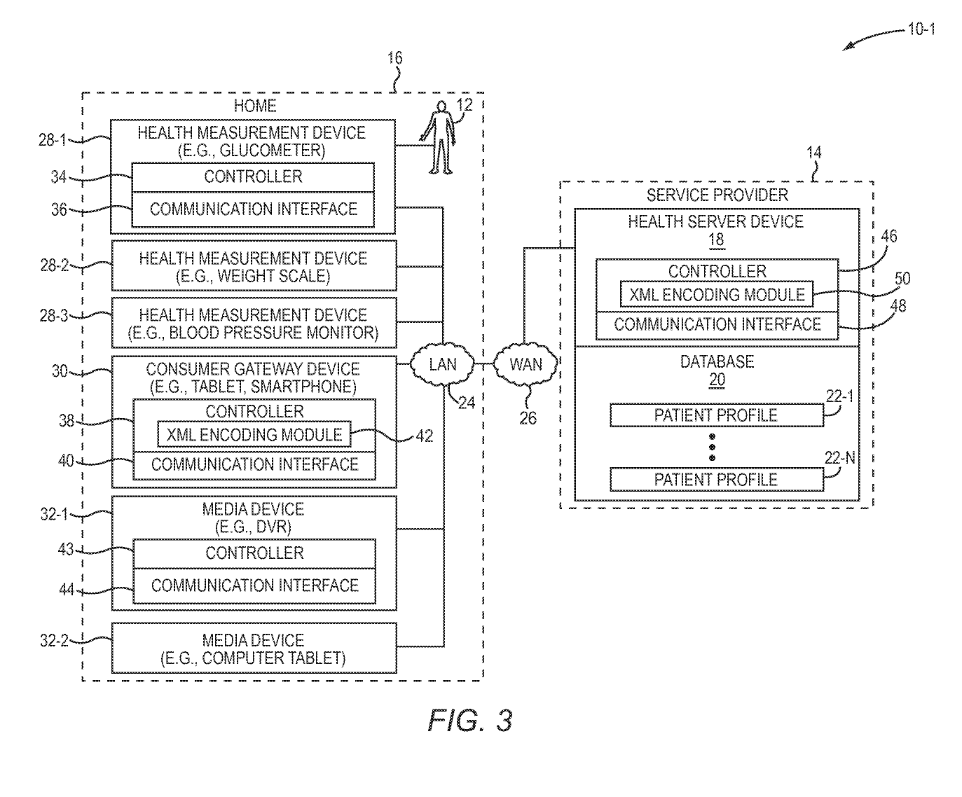

FIG. 3 is a block diagram of an environment 10-1 according to another embodiment. In this embodiment, the patient 12 has several health measurement devices (generally, HMDs) 28-1, 28-2, and 28-3 (generally, HMDs 28). The HMD 28-1 may comprise, for example, a wireless glucometer. The HMD 28-2 may comprise, for example, a wireless weight scale. The HMD 28-3 may comprise, for example, a wireless blood pressure monitor. The HMD 28-1 includes a controller 34, which is configured to provide the functionality described herein, including, for example, with respect to a glucometer, the appropriate functionality to determine blood glucose levels of the patient 12. The HMD 28-1 also includes a communication interface 36 configured to communicate with the LAN 24. While not illustrated, the HMDs 28-2, 28-3 may be similarly configured and include a controller configured to provide the functionality described herein, and a communication interface configured to communicate with the LAN 24.

In some embodiments, the consumer gateway device 30 may comprise, by way of non-limiting example, a dedicated device whose primary function is to receive health measurements from the HMDs 28 and provide health information to the health server device 18. In other embodiments, the consumer gateway device 30 may comprise, by way of non-limiting example, a computer tablet, such as an Apple® iPad® or an Android®-based computer tablet that executes an application or a module that provides the functionality described herein; a Wi-Fi router; a STB; a computer; or a smartphone, such as an Apple® iPhone® or an Android®-based smartphone that executes an application or a module that provides the functionality described herein. The consumer gateway device 30 includes a controller 38 and a communication interface 40. In some embodiments, the consumer gateway device 30 also includes an XML encoding module 42, which is configured to encode information received from the HMDs 28 into an XML encoding scheme. Thus, the consumer gateway device 30 may provide XML encoded messages to the health server device 18 via the LAN 24.

In one embodiment, the XML encoding scheme is used to tag the health information with markup tags that describe the data in accordance with standardized Electronic Medical Record (EMR) formats such as, by way of non-limiting example, HL-7 format. Tagging the health information at the consumer gateway device 30 creates a relatively streamlined process whereby the health information can be easily integrated into the medical record of the patient 12 by the health server device 18. In addition, this allows for later direct integration, both real-time and batched, with third party EMR systems.

The home 16 may also include multiple media devices 32-1, 32-2 (generally, media devices 32). The media device 32-1 may comprise, for example, a DVR. The media device 32-2 may comprise, for example, a computer tablet. The media device 32-1 includes a controller 43 and a communication interface 44 configured to communicatively couple to the LAN 24. The media device 32-2 may be similarly configured and also include a controller and a communication interface.

The health server device 18 likewise contains a controller 46 suitable for carrying out the functionality as described herein, and a communication interface 48 configured to communicate with the LAN 24 via the WAN 26. The controller 46 may also include an XML encoding module 50, which is configured to receive the XML encoded messages from the consumer gateway device 30, and to extract the relevant health measurement data and store such health measurement data in an XML standard format in the patient profile 22. In one embodiment, the XML encoding module 50 maintains a descriptor of health measurements along with standardized XML tags that are compliant with health care standards. The database 20 may include a plurality of patient profiles 22-1-22-N (generally, patient profiles 22), each patient profile 22 associated with a different user or patient 12.

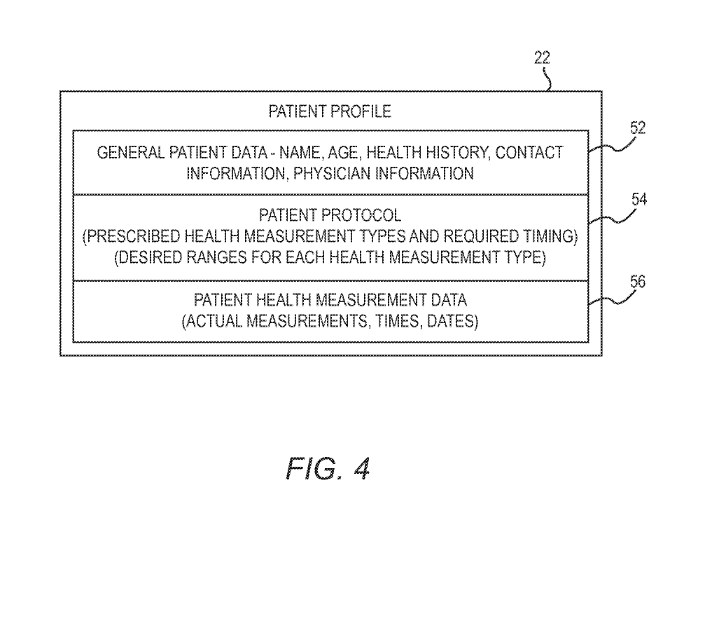

FIG. 4 is a block diagram of an example patient profile 22 illustrating example data that may be stored in the patient profile 22. The patient profile 22 may include a key field which is non-descriptive of the patient 12 in the event the associated health care provider wishes to not associate the health information of the patient 12 at the point of origin. In other embodiments, the patient profile 22 may include general patient data 52 regarding a particular patient 12, such as the name of the patient 12, the age of the patient 12, a health history associated with the patient 12, contact information for the patient 12, and contact information of a physician providing treatment to the patient 12. The patient profile 22 may also include a patient protocol 54, which contains the prescribed health measurement types and the required timing for taking health measurements via the HMDs 28. For example, the patient protocol 54 may indicate that the patient 12 is to take two health measurements a day via the HMD 28-1, one health measurement a day via the HMD 28-2, and two health measurements a day via the HMD 28-3. The patient protocol 54 may also indicate particular times of the day such health measurements should be taken. For example, the patient protocol 54 may indicate that blood pressure readings are to be taken via the HMD 28-3 in the morning between 6:00 a.m. and 8:00 a.m., and in the evening between 8:00 p.m. and 10:00 p.m.

The patient protocol 54 may also include desired ranges, thresholds, or some other quantifier, for each health measurement type. Thus, the patient protocol 54 may include a desired range of readings relating to blood glucose levels of the patient 12 for the HMD 28-1, a desired range of weights or a maximum change in weight of the patient 12 for the HMD 28-2, and a desired range of blood pressure of the patient 12 associated with the HMD 28-3. The patient profile 22 may also include patient health measurement data 56 that contains actual health measurements received from the HMDs 28-1-28-3 via the consumer gateway device 30 by the health server device 18 and stored in the patient profile 22. The patient health measurement data 56 may include the actual health measurements, the health measurement device type, i.e., such as a glucometer, a weight scale, or a blood pressure monitor, the time of day the health measurement was taken, as well as the date that the health measurement was taken.

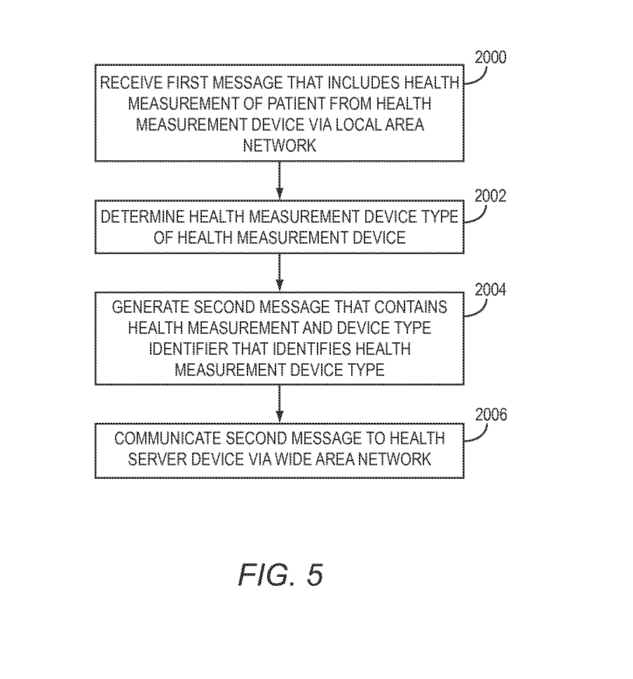

FIG. 5 is a flowchart of a method for communicating health data to the health server device 18 via the consumer gateway device 30 according to one embodiment. For purposes of illustration, assume that the patient 12 uses the HMD 28-3 to take a blood pressure reading. After the HMD 28-3 has successfully taken the blood pressure reading of the patient 12, the HMD 28-3 sends the blood pressure reading via the LAN 24 to the consumer gateway device 30. The consumer gateway device 30 receives a first message that includes the health measurement of the patient 12, in this example, the blood pressure reading, from the HMD 28-3 (FIG. 5, block 2000). In one embodiment, the consumer gateway device 30 determines a type of the HMD 28-3 (FIG. 5, block 2002). In one embodiment, each HMD 28 may include in the messages sent to the consumer gateway device 30 a HMD type that identifies the type of the HMD 28. In other embodiments, the consumer gateway device 30 may identify the HMD type based on other information obtained in the message, such as a source address of the message. Information, such as a cross-reference table, may be pre-configured into the consumer gateway device 30 such that the consumer gateway device 30 is aware of the source address of each of the HMDs 28, and based on the source address, the HMD type.

The consumer gateway device 30 generates a second message that contains the health measurement and the device type that identifies the type of HMD device (FIG. 5, block 2004). In some embodiments, the XML encoding module 50 of the consumer gateway device 30 encodes this information utilizing an XML tag. The encoding includes a field description of the data (e.g. <Daily_AM_Weight>) stored in a local look-up table on the consumer gateway device 30 that would be appended to the data prior to transmission to the health server device 18.

The consumer gateway device 30 communicates the second message to the health server device 18 via the WAN 26 (FIG. 5, block 2006). As discussed above, the health server device 18 receives the second message from the consumer gateway device 30. In one embodiment, the XML encoding module 50 of the health server device 18 utilizes XML encoding to further encode the health measurement into a standardized HL-7 format and stores the health measurement into the appropriate patient profile 22 along with other relevant information such as, for example, the time and date of the health measurement. This process may occur repeatedly multiple times a day for a prescribed period of time.

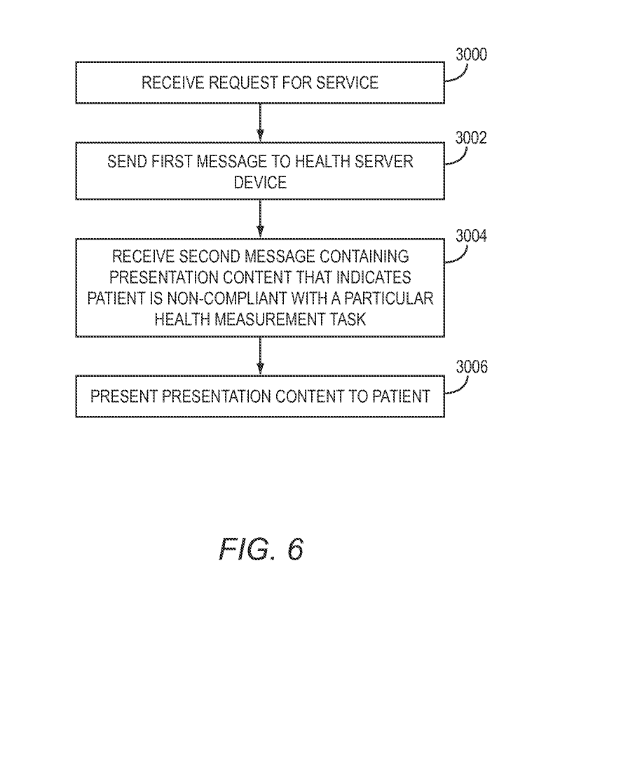

As discussed previously, in some embodiments, the health server device 18 monitors compliance of the patient protocol 54 when the patient 12 seeks a service from the media device 32. In this regard, FIG. 6 is a flowchart of a method performed by a media device 32 for ensuring compliance with a patient protocol prior to providing the patient 12 services from the respective media device 32, according to one embodiment. For purposes of illustration, assume that the patient 12 desires to watch programming from the media device 32-1, which, in this example, may be a DVR. The patient 12 presses a button on a remote control or otherwise enters information directly into the media device 32-1 seeking a programming channel from the media device 32-1. The media device 32-1 receives a request for service (FIG. 6, block 3000). The media device 32-1 generates and sends a first message to the health server device 18 indicating that the patient 12 seeks service from the media device 32-1 (FIG. 6, block 3002). The health server device 18, as discussed above, accesses the respective patient profile 22 associated with the patient 12 and makes a patient compliance determination based on the patient profile 22. Assume that the patient compliance determination is that the patient 12 is out-of-compliance. In one embodiment, the health server device 18 generates a second message containing presentation content that indicates that the patient 12 is non-compliant with a particular health measurement task identified in the patient protocol 54. The media device 32-1 receives the second message containing the presentation content that indicates the patient 12 is non-compliant with a particular health measurement task (FIG. 6, block 3004). The second message may be in any desirable format, and may comprise, in some embodiments, a short message service message. The media device 32-1 presents the presentation content to the patient 12 (FIG. 6, block 3006). In the example where the media device 32-1 comprises, for example, a DVR, the presentation content may be presented on a television that is coupled to the media device 32-1. The presentation content preferably covers all or substantially all of the viewing area of the television to sufficiently obstruct the viewing experience of the patient 12, and preferably, specifically identifies to the patient 12 which health measurement task with which the patient 12 is out-of-compliance. Thus, the patient 12 is denied, or otherwise inhibited from receiving services from the media device 32-1 because the patient 12 has not complied with the particular health measurement task identified in the patient protocol 54 associated with the patient 12.

Assume for purposes of illustration, that the particular health measurement task with which the patient 12 is non-compliant relates to taking a weight measurement of the patient 12. Assume further that after being presented with the presentation content via the media device 32-1, the patient 12 then utilizes the HMD 28-2 to weigh herself. The HMD 28-2, after completing the measurement of the weight of the patient 12, provides the patient health measurement data 56 to the consumer gateway device 30 via the LAN 24. The consumer gateway device 30 then, as discussed above, encodes the patient health measurement data 56 that identifies the weight of the patient 12, along with the HMD type identifying the type of device of the HMD 28-2 (e.g., a weight scale), encodes this information into an XML format, and provides this health information to the health server device 18. The health server device 18, as discussed above, ultimately stores this information in the appropriate patient profile 22.

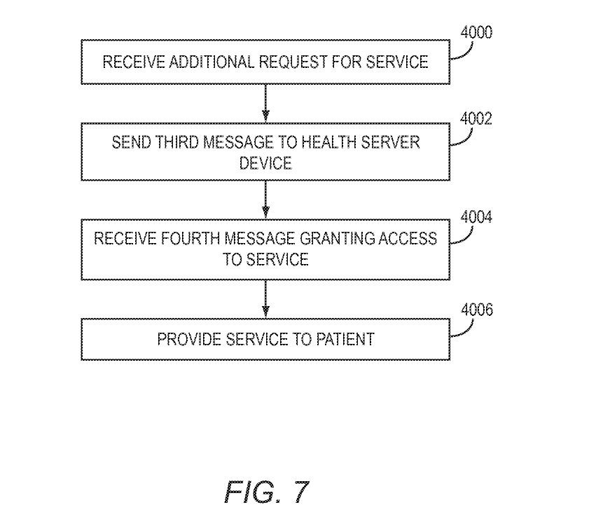

FIG. 7 is a flowchart of a method for subsequently providing a service via the media device 32 after the patient 12 has first been denied service from the media device 32 due to non-compliance with the patient protocol 54. In this example, the patient 12, after having weighed themselves via the HMD 28-2, may select a “retry” button or “try again” button that is displayed along with the presentation content on the television. Thus, the media device 32-1 receives an additional request for service via the media device 32-1 (FIG. 7, block 4000). The media device 32-1 generates a third message that indicates that the patient 12 is seeking a service from the media device 32-1 and sends the third message to the health server device 18 (FIG. 7, block 4002). The health server device 18 receives the third message and again accesses the patient profile 22 associated with the patient 12. Since, in the interim between the first request for service and the additional request for service, the patient 12 has weighed herself via the HMD 28-2, the patient compliance determination made by the health server device 18 based on the patient profile 22 is now a patient-in-compliance determination. The health server device 18 sends a fourth message to the media device 32-1 granting access to the requested service. The media device 32-1 receives the fourth message granting access to the service (FIG. 7, block 4004). The media device 32-1 then provides the requested service to the patient 12 (FIG. 7, block 4006).

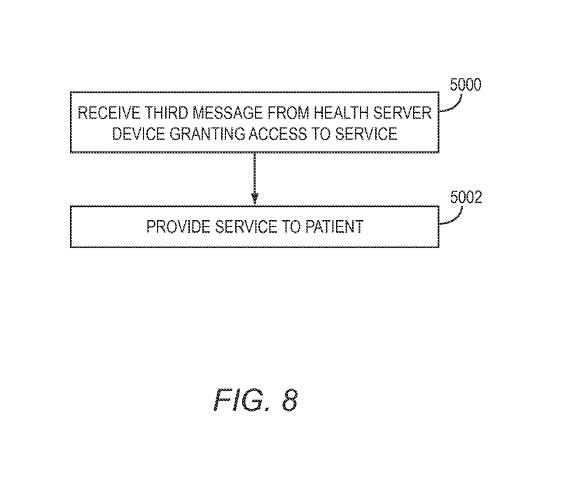

FIG. 8 is a flowchart of a method by which the patient 12 may gain access to a requested service from the media device 32-1 after being denied access to the service, according to another embodiment. In this embodiment, assume, as with regard to FIG. 7, that the user or patient 12 performed the health measurement task, and as described above, the relevant health measurement was provided to the health server device 18. In this embodiment, rather than waiting for the patient 12 to retry gaining access to the service as described with regard to FIG. 7, the health server device 18 automatically determines that the patient 12 is now in compliance with the patient protocol 54 identified in the respective patient profile 22, and sends the media device 32-1 a message granting the patient 12 access to the requested service. The media device 32-1, thus, prior to receiving any additional attempt to access the service by the patient 12, receives a third message from the health server device 18 granting access to the service (FIG. 8, block 5000). The media device 32-1 then provides the requested service to the patient 12 (FIG. 8, block 5002). Thus, in this embodiment, the patient 12 need not retry the service because the service will automatically be provided to the patient 12 upon compliance with the patient protocol 54.

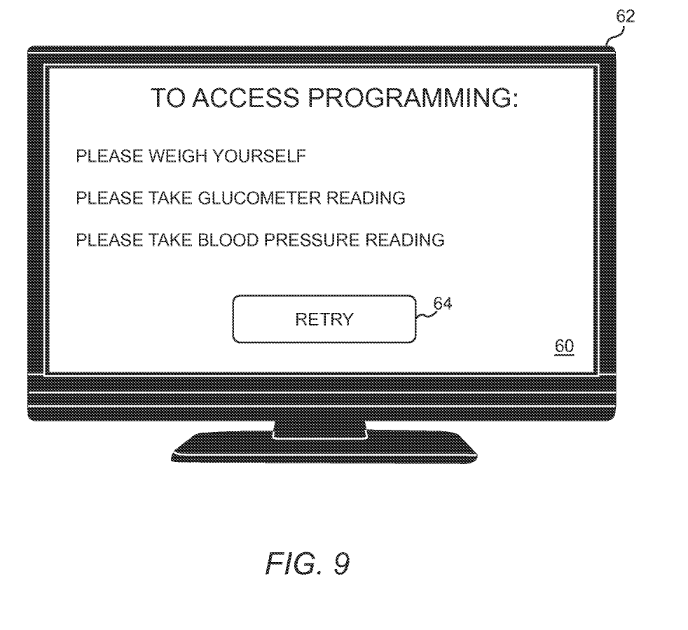

FIG. 9 is an example of presentation content 60 that may be presented on a television 62 that may be coupled to the media device 32-1. The presentation content 60 in this example informs the patient 12 that the patient 12 is out-of-compliance with three health measurement tasks. In particular, the patient 12 needs to weigh herself, take a glucometer reading, and take a blood pressure reading. In this embodiment, after performing the identified health measurement tasks, the patient 12 may select a retry control 64 via, for example, a remote control, to gain access to the requested programming service.

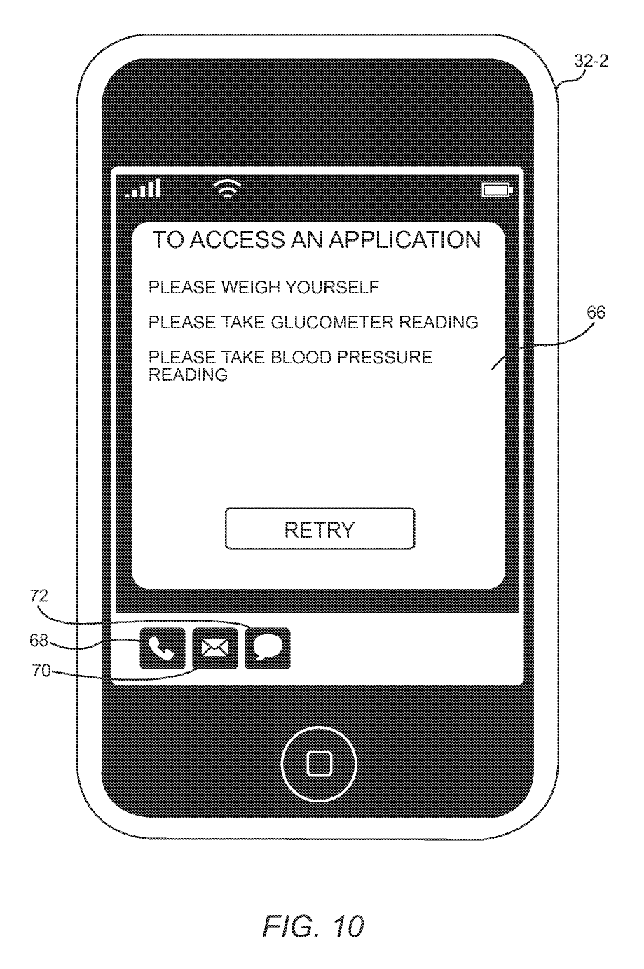

FIG. 10 is a diagram of example presentation content that may be displayed on a media device 32 that comprises a computer tablet or a smartphone. Assume for purposes of illustration that the media device 32-2 comprises a smartphone, such as an Apple® iPhone®. In this embodiment, assume that the patient 12 initiated the appropriate actions to gain access to the media device 32-2, such as entering a PIN code. The media device 32-2 upon receiving the request from the patient 12 to access the media device 32-2, generates a message and sends the message to the health server device 18, as described above with regard to FIG. 6. Assume again for purposes of illustration that the health server device 18 determines that the patient 12 is out-of-compliance with three health measurement tasks, in particular, the patient 12 has not weighed herself, has not taken a glucometer reading, and has not taken a blood pressure reading. The health server device 18 sends a message to the media device 32-2 containing presentation content 66, which informs the patient 12 which health measurement tasks the patient 12 is not in compliance with. However, in this embodiment, the media device 32-2 may still permit the patient 12 to receive one or more fundamental services provided by the media device 32-2 such as access to telephone service via the telephone icon 68, access to email service via an email icon 70, and access to text messaging service via a text message icon 72. Thus, in some embodiments, despite being out-of-compliance with a particular patient protocol 54, the media device 32-2 may still allow the patient 12 to have certain limited functionality of the respective media device 32-2.

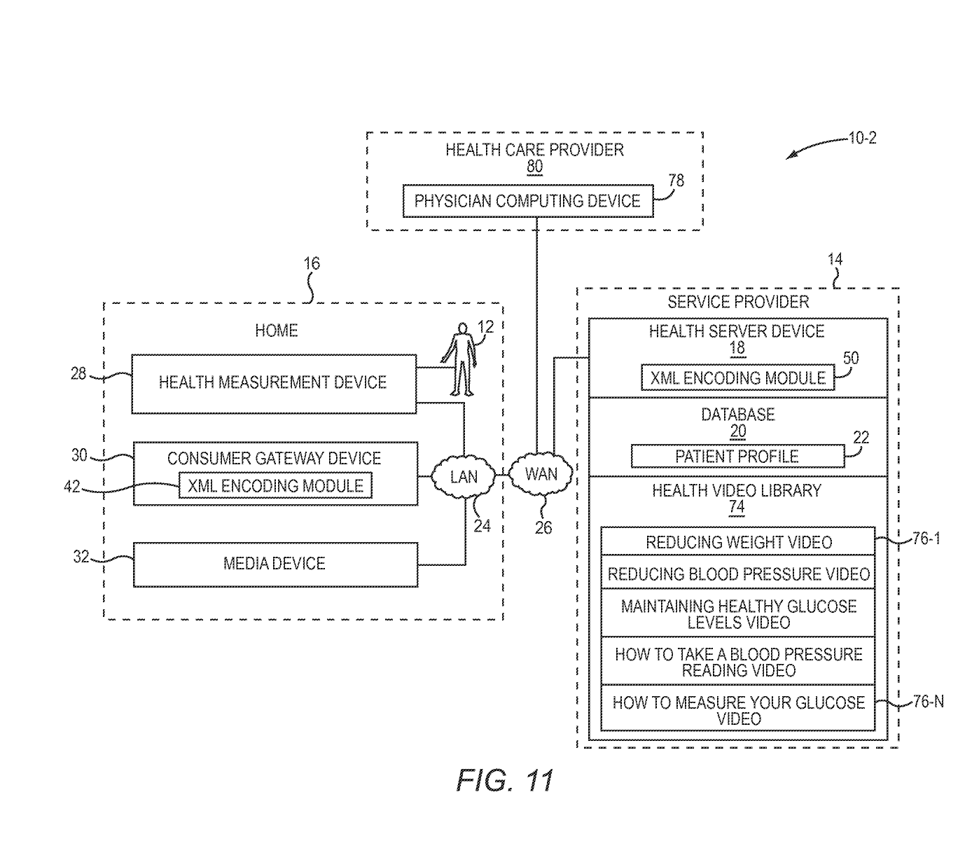

FIG. 11 is a block diagram of an environment 10-2 according to another embodiment. In this embodiment, the health server device 18 monitors the actual health measurements received from the consumer gateway device 30 and determines whether the actual health measurements are desirable measurements based on desired values and/or desired ranges identified in the respective patient profile 22 associated with the patient 12. If the health measurements are undesirable measurements, such as being outside the desired ranges or otherwise deviating from a desired value, then the health server device 18 may communicate to the patient 12 via the media device 32 presentation content, such as links for tips, tutorials or other educational material related to improving health measurements, which are maintained in a health video library 74. For example, the health video library 74 may contain a plurality of health videos 76-1-76-N (generally, health videos 76), each of which may provide useful information to the patient 12 regarding a particular health issue. In particular, each health video 76 may be associated with a particular health measurement type, and a particular health video 76 may be selected by the health server device 18 based on the health measurement type of the undesirable health measurement. For example, if the most recent weight measurement of the patient 12 exceeded a desired range identified in the patient profile 22, the health server device 18 may access the health video library 74 and identify a Reducing Weight Video 76-1 based on the Reducing Weight Video 76-1 being designated as a weight measurement type. The Reducing Weight Video 76-1 may provide information on ways in which the patient 12 may reduce their weight. The health server device 18 then provides the Reducing Weight Video 76-1 to the patient 12 via the media device 32. The patient 12 may be required to view the Reducing Weight Video 76-1 prior to gaining access to the services of the media device 32.

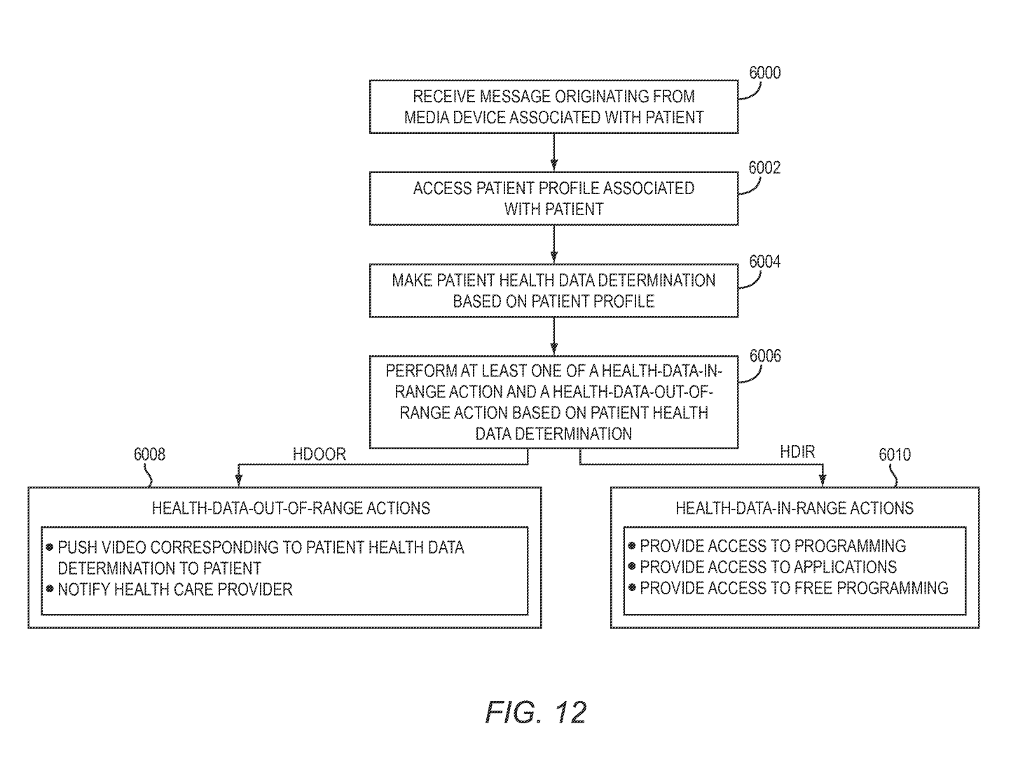

FIG. 12 is a flowchart of a method by which the health server device 18 monitors health measurements of the patient 12 according to one embodiment, and will be discussed in conjunction with FIG. 11. Assume that the patient 12 desires to seek a service from the media device 32. Assume further that the media device 32 comprises a STB that is coupled to the television 62. The health server device 18 receives a message originating from the media device 32 indicating that the patient 12 seeks a service from the media device 32 (FIG. 12, block 6000). The health server device 18 accesses the patient profile 22 associated with the patient 12 (FIG. 12, block 6002). The health server device 18 makes a patient health data determination based on the patient profile 22 (FIG. 12, block 6004). The health server device 18 then performs either a health-data-in-range (HDIR) action or a health-data-out-of-range (HDOOR) action based on the patient health data determination (FIG. 12, block 6006). A HDOOR action 6008 may include, by way of non-limiting example, selecting a particular health video 76 associated with the particular health issue with which the health measurement of the patient 12 is out of range and then push, or otherwise communicate the respective health video 76 to the media device 32 for presentation to the patient 12. After presenting the health video 76 to the patient 12, the media device 32 may automatically provide the patient 12 the requested service. In some embodiments, the health server device 18 may also generate and send a message to a physician computing device 78 associated with a health care provider 80 identified in the patient profile 22. The message may identify one or more actual health measurements of the patient 12 to inform the health care provider 80 that the health measurement(s) are outside of a desired range.

A HDIR action 6010 may include, by way of non-limiting example, sending a message to the media device 32 that grants access to the requested service, or access to applications that execute on the media device 32, or in some embodiments, one or more free programming channels may be offered to the patient 12 so long as the patient 12 remains within compliance of the patient protocol 54 as well as within the desired ranges of the health measurements. In addition to, or alternatively, a link to a coupon, a link to an entertainment ticket, such as a movie or other event, a credit for a free video-on-demand movie, or any other desired positive reinforcement mechanism may be provided to the patient 12.

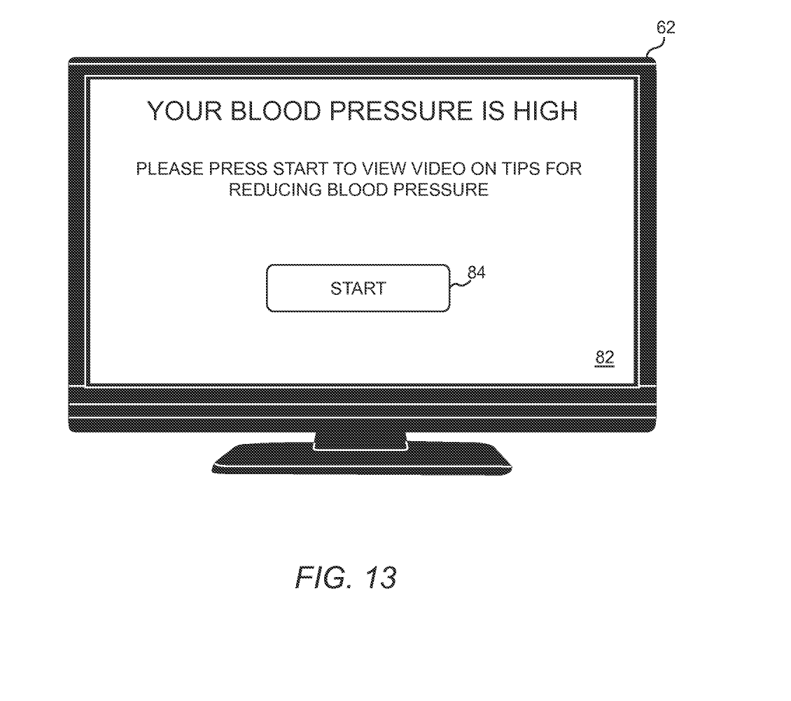

FIG. 13 is a block diagram of example presentation content that may be displayed or otherwise presented by the media device 32 on the television 62 when the health server device 18 makes a patient health data determination that the health measurement received from the patient 12 is out of a desired range. In this example, assume that the blood pressure of the patient 12 exceeds the desired blood pressure range. The health server device 18 may select presentation content that, when displayed to the patient 12 via the media device 32 on the television 62 indicates to the patient 12 that their blood pressure is high. The patient 12 may be prevented from otherwise utilizing the media device 32 until the patient 12 selects a start control 84 and views the health video 76 provided by the health server device 18 regarding tips for reducing blood pressure.

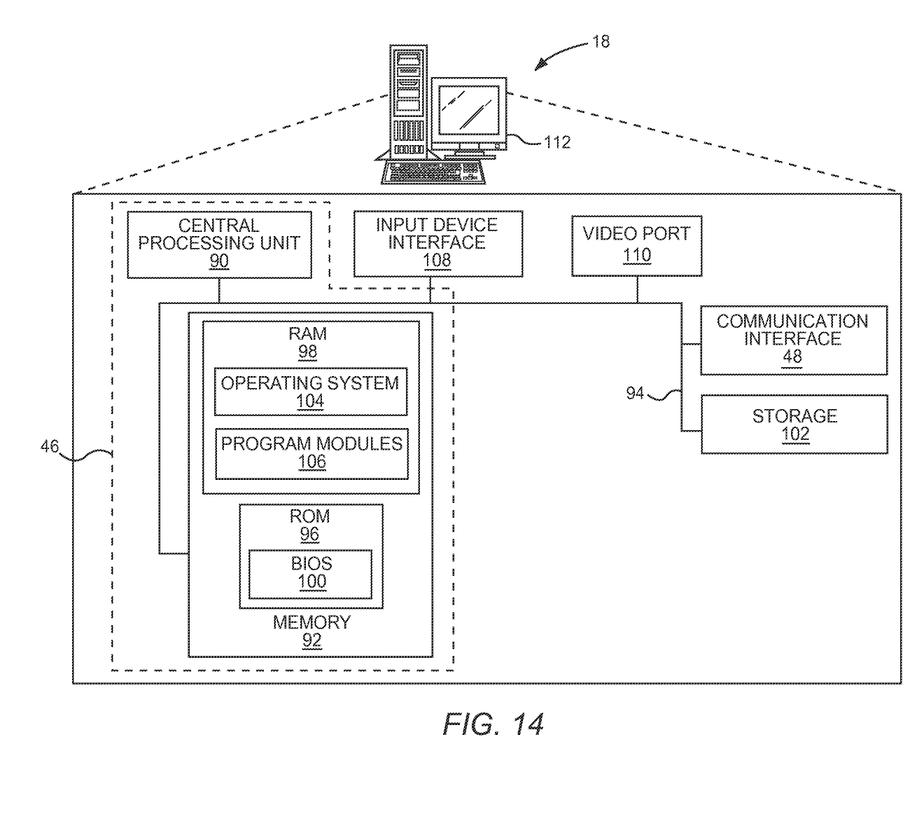

FIG. 14 is a block diagram of the health server device 18 according to one embodiment. The health server device 18 may comprise any computing or processing device capable of executing software instructions to implement the functionality described herein, such as a work station, telecommunications switch, head end processing device, or the like. The health server device 18 includes a central processing unit 90, a system memory 92, and a system bus 94. The system bus 94 provides an interface for system components including, but not limited to, the system memory 92 and the central processing unit 90. The central processing unit 90 can be any commercially available or proprietary processor.

The system bus 94 may be any of several types of bus structures that may further interconnect to a memory bus (with or without a memory controller), a peripheral bus, and/or a local bus using any of a variety of commercially available bus architectures. The system memory 92 may include non-volatile memory 96 (e.g., read only memory (ROM), erasable programmable read only memory (EPROM), electrically erasable programmable read only memory (EEPROM), etc.) and/or volatile memory 98 (e.g., random access memory (RAM)). A basic input/output system (BIOS) 100 may be stored in the non-volatile memory 96, and can include the basic routines that help to transfer information between elements within the health server device 18. The volatile memory 98 may also include a high-speed RAM, such as static RAM for caching data.

The health server device 18 may further include or be coupled to a computer-readable storage 102, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The computer-readable storage 102 and other drives, associated with computer-readable media and computer-usable media, may provide non-volatile storage of data, data structures, computer-executable instructions, and the like, including, for example, the database 20 and the health video library 74. Although the description of computer-readable media above refers to an HDD, it should be appreciated by those skilled in the art that other types of media which are readable by a computer, such as Zip disks, magnetic cassettes, flash memory cards, cartridges, and the like, may also be used in the exemplary operating environment, and further, that any such media may contain computer-executable instructions for performing novel methods of the disclosed architecture.

A number of modules can be stored in the computer-readable storage 102 and in the volatile memory 98, including an operating system 104 and one or more program modules 106, which may implement the functionality described herein in whole or in part, including, for example, functionality associated with the XML encoding module 50, and other processing and functionality described herein. The program modules 106 may include a health monitoring application in which some or all of the functionality disclosed herein is implemented. It is to be appreciated that the embodiments can be implemented with various commercially available operating systems 104 or combinations of operating systems 104.

All or a portion of the embodiments may be implemented as a computer program product stored on a transitory or non-transitory computer-usable or computer-readable storage medium, such as the computer-readable storage 102, which includes complex programming instructions, such as complex computer-readable program code, configured to cause the central processing unit 90 to carry out the steps described herein. Thus, the computer-readable program code can comprise software instructions for implementing the functionality of the embodiments described herein when executed on the central processing unit 90. The central processing unit 90, in conjunction with the program modules 106 in the volatile memory 98, may serve as the controller 46 for the health server device 18 that is configured to, or adapted to, implement the functionality described herein.

A user, such as an operator, may be able to enter commands and information into the health server device 18 through one or more input devices, such as, for example, a keyboard (not illustrated), a pointing device such as a mouse (not illustrated), or a touch-sensitive surface (not illustrated). Other input devices may include a microphone, an infrared (IR) remote control, a joystick, a game pad, a stylus pen, or the like. These and other input devices may be connected to the central processing unit 90 through an input device interface 108 that is coupled to the system bus 94, but can be connected by other interfaces such as a parallel port, an Institute of Electrical and Electronic Engineers (IEEE) 1394 serial port, a Universal Serial Bus (USB) port, an IR interface, and the like.

The health server device 18 may also include the communication interface 48, suitable for communicating with the WAN 26 and other networks as appropriate or desired. The health server device 18 may also include a video port 110 interfacing with a display 112 that provides information to the operator. As previously discussed, the functionality described herein may be implemented on a single health server device 18 or functionality may be divided over multiple health server devices 18, depending on a desired implementation.

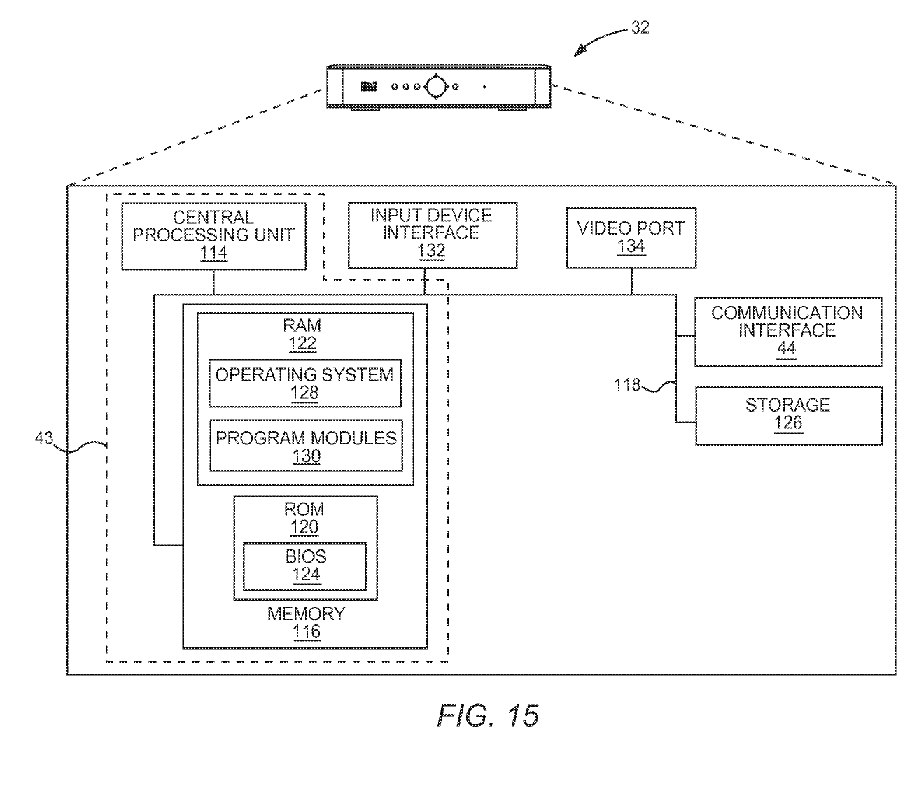

FIG. 15 is a block diagram of the media device 32 according to one embodiment. The media device 32 may comprise any computing or processing device capable of including firmware, hardware, and/or executing software instructions to implement the functionality described herein, such as a STB, a DVR, a computer tablet, a gaming console, a media streaming device, a smartphone, or the like. The media device 32 includes a central processing unit 114, a system memory 116, and a system bus 118. The system bus 118 provides an interface for system components including, but not limited to, the system memory 116 and the central processing unit 114. The central processing unit 114 can be any commercially available or proprietary processor.

The system bus 118 may be any of several types of bus structures that may further interconnect to a memory bus (with or without a memory controller), a peripheral bus, and/or a local bus using any of a variety of commercially available bus architectures. The system memory 116 may include non-volatile memory 120 (e.g., read only memory (ROM), erasable programmable read only memory (EPROM), electrically erasable programmable read only memory (EEPROM), etc.) and/or volatile memory 122 (e.g., random access memory (RAM)). A basic input/output system (BIOS) 124 may be stored in the non-volatile memory 120, and can include the basic routines that help to transfer information between elements within the media device 32. The volatile memory 122 may also include a high-speed RAM, such as static RAM for caching data.

The media device 32 may further include or be coupled to a computer-readable storage 126, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The computer-readable storage 126 and other drives, associated with computer-readable media and computer-usable media, may provide non-volatile storage of data, data structures, computer-executable instructions, and the like. Although the description of computer-readable media above refers to an HDD, it should be appreciated by those skilled in the art that other types of media which are readable by a computer, such as Zip disks, magnetic cassettes, flash memory cards, cartridges, and the like, may also be used in the exemplary operating environment, and further, that any such media may contain computer-executable instructions for performing novel methods of the disclosed architecture.

A number of modules can be stored in the computer-readable storage 126 and in the volatile memory 122, including an operating system 128 and one or more program modules 130, which may implement the functionality described herein in whole or in part. It is to be appreciated that the recited embodiments can be implemented with the various commercially available operating systems 128 or combinations of the operating systems 128.

All or a portion of the embodiments may be implemented as a computer program product stored on a transitory or non-transitory computer-usable or computer-readable storage medium, such as the computer-readable storage 126, which includes complex programming instructions, such as complex computer-readable program code, configured to cause the central processing unit 114 to carry out the steps described herein. Thus, the computer-readable program code can comprise software instructions for implementing the functionality of the embodiments described herein when executed on the central processing unit 114. The central processing unit 114, in conjunction with the program modules 130 in the volatile memory 122, may serve as the controller 43 for the media device 32 that is configured to, or adapted to, implement the functionality described herein.

A user, such as the patient 12, may be able to enter commands and information into the media device 32 through one or more input devices, such as, for example, a hard or soft keyboard (not illustrated), a pointing device such as a mouse (not illustrated), or a touch-sensitive surface (not illustrated). Other input devices may include a microphone, an infrared (IR) remote control, a joystick, a game pad, a stylus pen, or the like. These and other input devices may be connected to the central processing unit 114 through an input device interface 132 that is coupled to the system bus 118, but can be connected by other interfaces such as a parallel port, an Institute of Electrical and Electronic Engineers (IEEE) 1394 serial port, a Universal Serial Bus (USB) port, an IR interface, and the like.

The media device 32 may also include the communication interface 44, suitable for communicating with the LAN 24 and other networks as appropriate or desired. The media device 32 may also include a video port 134 configured to interface with a display, such as the television 62, that provides information and other services to the patient 12, such as television programming, movies, and the like.

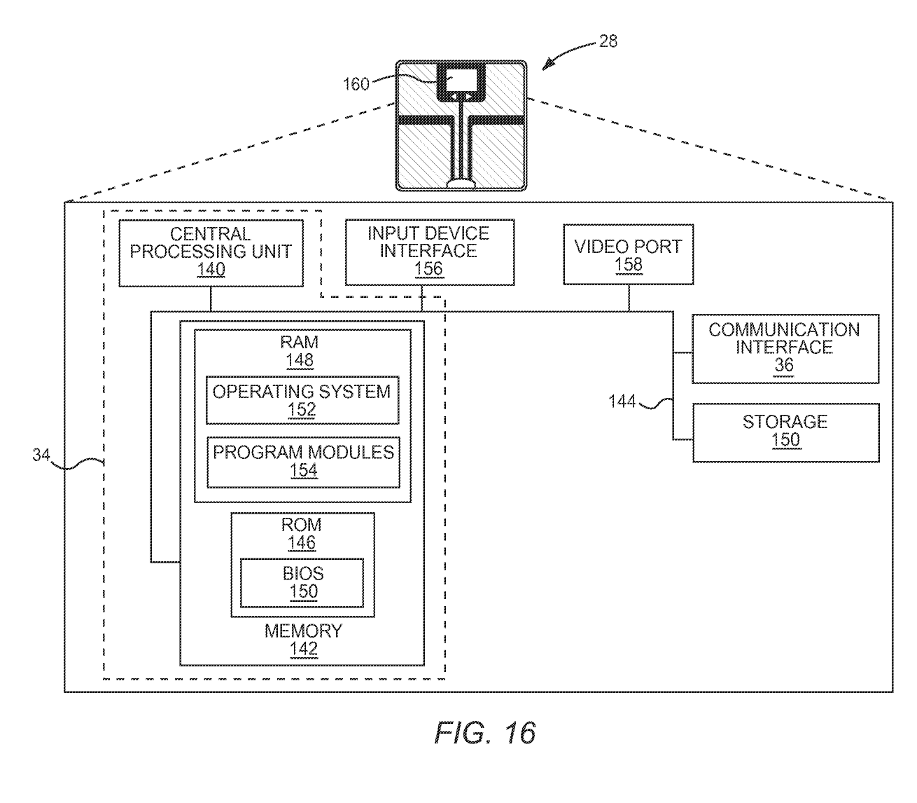

FIG. 16 is a block diagram of the HMD 28 according to one embodiment. The HMD 28 may comprise any computing or processing device capable of including firmware, hardware, and/or executing software instructions to implement the functionality described herein, such as a STB, a DVR, a computer tablet, a gaming console, a media streaming device, a smartphone, or the like. The HMD 28 includes a central processing unit 140, a system memory 142, and a system bus 144. The system bus 144 provides an interface for system components including, but not limited to, the system memory 142 and the central processing unit 140. The central processing unit 140 can be any commercially available or proprietary processor.

The system bus 144 may be any of several types of bus structures that may further interconnect to a memory bus (with or without a memory controller), a peripheral bus, and/or a local bus using any of a variety of commercially available bus architectures. The system memory 142 may include non-volatile memory 146 (e.g., read only memory (ROM), erasable programmable read only memory (EPROM), electrically erasable programmable read only memory (EEPROM), etc.) and/or volatile memory 148 (e.g., random access memory (RAM)). A basic input/output system (BIOS) 150 may be stored in the non-volatile memory 146, and can include the basic routines that help to transfer information between elements within the HMD 28. The volatile memory 148 may also include a high-speed RAM, such as static RAM for caching data.

The HMD 28 may further include or be coupled to a computer-readable storage 150, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The computer-readable storage 150 and other drives, associated with computer-readable media and computer-usable media, may provide non-volatile storage of data, data structures, computer-executable instructions, and the like. Although the description of computer-readable media above refers to an HDD, it should be appreciated by those skilled in the art that other types of media which are readable by a computer, such as Zip disks, magnetic cassettes, flash memory cards, cartridges, and the like, may also be used in the exemplary operating environment, and further, that any such media may contain computer-executable instructions for performing novel methods of the disclosed architecture.

A number of modules can be stored in the computer-readable storage 150 and in the volatile memory 148, including an operating system 152 and one or more program modules 154, which may implement the functionality described herein in whole or in part, including, for example the ability to take a desired health measurement, and communicate the health measurement to the consumer gateway device 30. It is to be appreciated that the embodiments can be implemented with various commercially available operating systems 152 or combinations of operating systems 152.

All or a portion of the embodiments may be implemented as a computer program product stored on a transitory or non-transitory computer-usable or computer-readable storage medium, such as the computer-readable storage 150, which includes complex programming instructions, such as complex computer-readable program code, configured to cause the central processing unit 140 to carry out the steps described herein. Thus, the computer-readable program code can comprise software instructions for implementing the functionality of the embodiments described herein when executed on the central processing unit 140. The central processing unit 140, in conjunction with the program modules 154 in the volatile memory 148, may serve as the controller 34 for the HMD 28 that is configured to, or adapted to, implement the functionality described herein.

A user, such as the patient 12, may have a health measurement taken via one or more input devices, such as, for example, a blood pressure cuff, a weight sensitive surface, or the like, depending on the functionality of the particular HMD 28. The patient 12 may also be able to enter one or more configuration commands through a keyboard (not illustrated), a pointing device such as a mouse (not illustrated), or a touch-sensitive surface (not illustrated). Such input devices may be connected to the central processing unit 140 through an input device interface 156 that is coupled to the system bus 144, but can be connected by other interfaces such as a parallel port, an Institute of Electrical and Electronic Engineers (IEEE) 1394 serial port, a Universal Serial Bus (USB) port, an IR interface, and the like.

The HMD 28 may also include the communication interface 36, suitable for communicating with the LAN 24 and other networks as appropriate or desired. The HMD 28 may also include a video port 158 configured to interface with a display 160, to provide the patient 12 information regarding the particular health measurement, and/or to aid the patient in configuring the HMD 28.

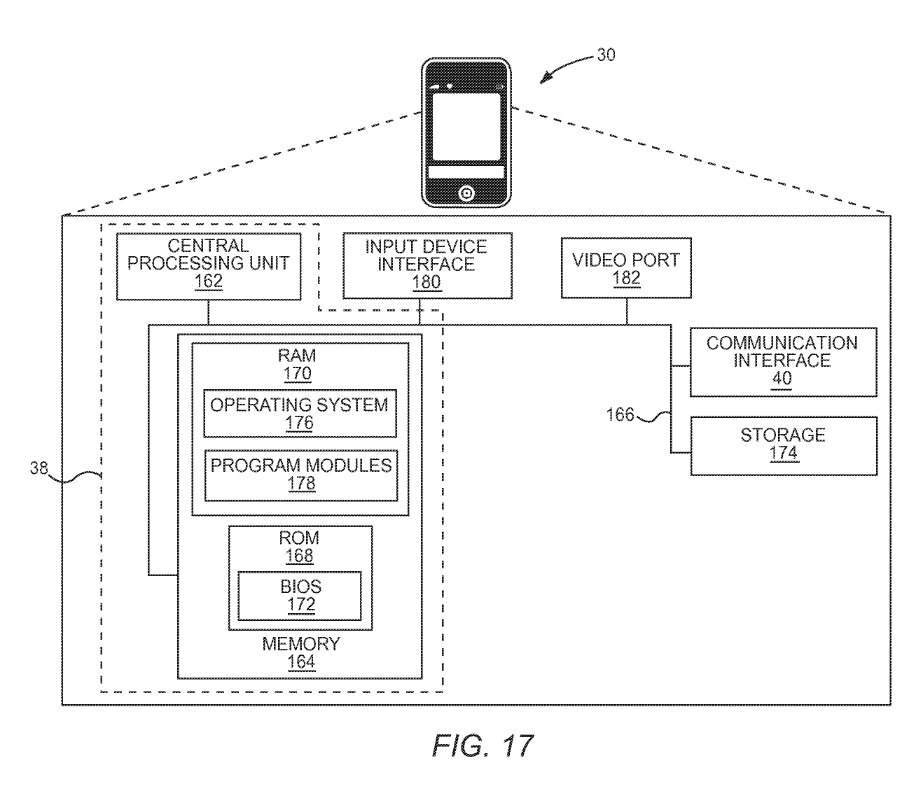

FIG. 17 is a block diagram of the consumer gateway device 30 according to one embodiment. The consumer gateway device 30 may comprise any computing or processing device capable of including firmware, hardware, and/or executing software instructions to implement the functionality described herein, such as a dedicated processing device, a wireless adapter or router, a laptop or desktop computer, a STB, a DVR, a computer tablet, a gaming console, a media streaming device, a smartphone, or the like. The consumer gateway device 30 includes a central processing unit 162, a system memory 164, and a system bus 166. The system bus 166 provides an interface for system components including, but not limited to, the system memory 164 and the central processing unit 162. The central processing unit 162 can be any commercially available or proprietary processor.

The system bus 166 may be any of several types of bus structures that may further interconnect to a memory bus (with or without a memory controller), a peripheral bus, and/or a local bus using any of a variety of commercially available bus architectures. The system memory 164 may include non-volatile memory 168 (e.g., read only memory (ROM), erasable programmable read only memory (EPROM), electrically erasable programmable read only memory (EEPROM), etc.) and/or volatile memory 170 (e.g., random access memory (RAM)). A basic input/output system (BIOS) 172 may be stored in the non-volatile memory 168, and can include the basic routines that help to transfer information between elements within the consumer gateway device 30. The volatile memory 170 may also include a high-speed RAM, such as static RAM for caching data.

The consumer gateway device 30 may further include or be coupled to a computer-readable storage 174, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The computer-readable storage 174 and other drives, associated with computer-readable media and computer-usable media, may provide non-volatile storage of data, data structures, computer-executable instructions, and the like. Although the description of computer-readable media above refers to an HDD, it should be appreciated by those skilled in the art that other types of media which are readable by a computer, such as Zip disks, magnetic cassettes, flash memory cards, cartridges, and the like, may also be used in the exemplary operating environment, and further, that any such media may contain computer-executable instructions for performing novel methods of the disclosed architecture.

A number of modules can be stored in the computer-readable storage 174 and in the volatile memory 170, including an operating system 176 and one or more program modules 178, which may implement the functionality described herein in whole or in part, including, for example functionality associated with the XML encoding module 42, and the ability communicate health information to the health server device 18. It is to be appreciated that the embodiments can be implemented with various commercially available operating systems 176 or combinations of the operating systems 176.

All or a portion of the embodiments may be implemented as a computer program product stored on a transitory or non-transitory computer-usable or computer-readable storage medium, such as the computer-readable storage 174, which includes complex programming instructions, such as complex computer-readable program code, configured to cause the central processing unit 162 to carry out the steps described herein. Thus, the computer-readable program code can comprise software instructions for implementing the functionality of the embodiments described herein when executed on the central processing unit 162. The central processing unit 162, in conjunction with the program modules 178 in the volatile memory 170, may serve as the controller 38 for the consumer gateway device 30 that is configured to, or adapted to, implement the functionality described herein.

A user, such as the patient 12, may be able to enter one or more commands through a keyboard (not illustrated), a pointing device such as a mouse (not illustrated), or a touch-sensitive surface (not illustrated). Such input devices may be connected to the central processing unit 162 through an input device interface 180 that is coupled to the system bus 166, but can be connected by other interfaces such as a parallel port, an Institute of Electrical and Electronic Engineers (IEEE) 1394 serial port, a Universal Serial Bus (USB) port, an IR interface, and the like.

The consumer gateway device 30 may also include the communication interface 40, suitable for communicating with the HMDs 28, the LAN 24, and other networks and devices as appropriate or desired. The consumer gateway device 30 may also include a video port 182 configured to interface with a display, to provide the patient 12 information regarding the consumer gateway device 30 or to otherwise facilitate use of the consumer gateway device 30.

Those skilled in the art will recognize improvements and modifications to the preferred embodiments of the present disclosure. All such improvements and modifications are considered within the scope of the concepts disclosed herein and the claims that follow.

What is claimed is:

1. A method, comprising:
receiving, by a media device comprising a processor, a request for a service;
in response to receiving the request, sending a first message to a remote health server device;
receiving, from the remote health server device, a second message containing presentation content that indicates that a health measurement of a patient associated the media device is an undesirable health measurement; and
presenting, by the media device, the presentation content to the patient in lieu of the service.

2. The method of claim 1, wherein the service comprises presentation of a channel on the media device.

3. The method of claim 1, wherein the service comprises execution of an application on the media device.

4. The method of claim 1, wherein the media device comprises one of a computer tablet, a set-top box, a digital video recorder, a media streaming device, a tablet computer, or a smartphone.

5. The method of claim 1, wherein the presentation content comprises content related to improving future health measurements.

6. The method of claim 1, further comprising:
after the presentation content has been presented to the patient, providing the service to the patient.

7. A method, comprising:
receiving, by a health server device comprising a processor, a first message originating from a media device associated with a patient, the first message indicating that the patient desires a service from the media device;
accessing a patient protocol of the patient;
making a health data determination based on the patient protocol; and
performing an action based on the health data determination.

8. The method of claim 7, wherein making the health data determination based on the patient protocol comprises:
accessing, from the patient protocol, a health measurement associated with the patient, the health measurement identifying a physiologic measurement of the patient;
determining that the health measurement is a desirable health measurement; and
wherein performing the action based on the health data determination comprises sending a message to the media device to provide the service to the patient.

9. The method of claim 7, wherein making the health data determination based on the patient protocol comprises:
accessing, from the patient protocol, a health measurement associated with the patient, the health measurement identifying a physiologic measurement of the patient;
determining that the health measurement is an undesirable health measurement; and
wherein performing the action based on the health data determination comprises sending presentation content to the media device for presentation to the patient in lieu of the service.

10. The method of claim 9, wherein the presentation content comprises content related to improving future health measurements.

11. The method of claim 9, further comprising:
determining a health measurement type of the health measurement;
accessing a library comprising a plurality of videos, each of the videos being designated as associated with a particular health measurement type;
selecting a video of the plurality of videos based on the health measurement type; and
sending the video of the plurality of videos as the presentation content to the media device for presentation to the patient in lieu of the service.

12. The method of claim 9, further comprising:
sending a message to a physician computing device associated with the patient, the message including the health measurement of the patient.

13. The method of claim 7, further comprising:
receiving, by the health server device, a message from a consumer gateway device, the message comprising information identifying:
the patient;
a health measurement device; and
a health measurement taken by the health measurement device.

14. The method of claim 13, further comprising:
storing information indicating the health measurement device and the health measurement in a patient profile associated with the patient.

15. The method of claim 7, wherein the service comprises programming provided on a condition that a most recent health measurement maintained by the health server device is a desirable health measurement;
wherein making the health data determination based on the patient protocol comprises determining that the most recent health measurement is a desirable health measurement; and
wherein performing the action based on the health data determination comprises sending a message to the media device to provide the programming to the patient.

16. A media device comprising:
a communication interface configured to communicate with a network; and
a processor coupled to the communication interface and configured to:
receive a request for a service;
in response to receiving the request, send a first message to a remote health server device;
receive, from the remote health server device, a second message containing presentation content that indicates that a health measurement of a patient associated the media device is an undesirable health measurement; and
present the presentation content to the patient in lieu of the service.

17. The media device according to claim 16, wherein the processor is further configured to, after the presentation content has been presented to the patient, provide the service to the patient.

18. The media device of claim 16, wherein the media device comprises one of a computer tablet, a set-top box, a digital video recorder, a media streaming device, tablet computer, or a smartphone.

19. A health server device comprising:
a communication interface configured to communicate with a network; and
a processor coupled to the communication interface and configured to:
receive a first message originating from a media device associated with a patient, the first message indicating that the patient desires a service from the media device;
access a patient protocol of the patient;
make a health data determination based on the patient protocol; and
perform an action based on the health data determination.

20. The health server device of claim 19, wherein to make the health data determination based on the patient protocol the processor is further configured to:
access, from the patient protocol, a health measurement associated with the patient, the health measurement identifying a physiologic measurement of the patient;
determine that the health measurement is a desirable health measurement; and
wherein to perform the action based on the health data determination, the processor is further configured to send a message to the media device to provide the service to the patient.

21. The health server device of claim 7, wherein to make the health data determination based on the patient protocol the processor is further configured to:
access, from the patient protocol, a health measurement associated with the patient, the health measurement identifying a physiologic measurement of the patient;
determine that the health measurement is an undesirable health measurement; and
wherein to perform the action based on the health data determination, the processor is further configured to send presentation content to the media device for presentation to the patient in lieu of the service.
